(19) United States
(12) Patent Application Publication
(10) Pub. No.: US 2026/0184961 A1
(43) Pub. Date: Jul. 2, 2026

(54) METHOD FOR REDUCING BENZOPYRENE AND PLASTICIZERS IN CAPSICUM OLEORESIN AND PRODUCT OBTAINED THEREBY

(71) Applicant: Henan Zhongda Hengyuan Biotechnology Stock Co., Ltd., Luohe City (CN)

(72) Inventors: Yihong LIU, Luohe City (CN); Ziheng JIN, Luohe City (CN); Yanjun WEN, Luohe City (CN); Tianyi PAN, Luohe City (CN); Huipeng PEI, Luohe City (CN); Sujing GU, Luohe City (CN); Yang LIU, Luohe City (CN); Haiyan HE, Luohe City (CN)

(73) Assignee: Henan Zhongda Hengyuan Biotechnology Stock Co., Ltd., Luohe City (CN)

(21) Appl. No.: 19/198,863

(22) Filed: May 5, 2025

(30) Foreign Application Priority Data
Dec. 30, 2024 (CN) 202411971025.6

(51) Int. Cl. C09F 1/02

(52) U.S. Cl. CPC C09F 1/02

(57) ABSTRACT

The present disclosure discloses a method for reducing benzopyrene and plasticizers in capsicum oleoresin and a product obtained thereby. The method includes steps: dissolving crude oil paste of capsicum oleoresin as raw material with a small molecular alcohol solvent to obtain a small molecular alcohol solution of capsicum oleoresin; performing extraction and back-extraction with CO₂ and small molecular alcohol solvents, respectively in a supercritical two-stage series mode; performing extracting on the small molecular alcohol solution by using CO₂ in extraction kettle I, to obtain a CO₂ extract phase and a raffinate phase (small molecular alcohol phase); obtaining high-purity capsicum oleoresin with reduced benzopyrene and plasticizers by conducting vacuum concentration and residual solvent removal on the small molecular alcohol phase; performing back-extraction on the CO₂ extract phase by using a small molecular alcohol solvent after the CO₂ extract phase enters extraction kettle II, so as to obtain small molecular alcohol phase, which is used for dissolving the crude oil paste of capsicum oleoresin in the next batch. The present disclosure improves the content and yield of refined capsicum oleoresin products and removing odor, benzopyrene, and plasticizers. Additionally, in the present disclosure, the removal efficiency of plasticizers, benzopyrene, and odors in capsicum oleoresin extracts may be improved, and the levels of benzopyrene, plasticizers, and inherent odors in the capsicum extract are reduced to extremely low levels, so that capsicum oleoresin may be significantly superior to products produced in prior art.

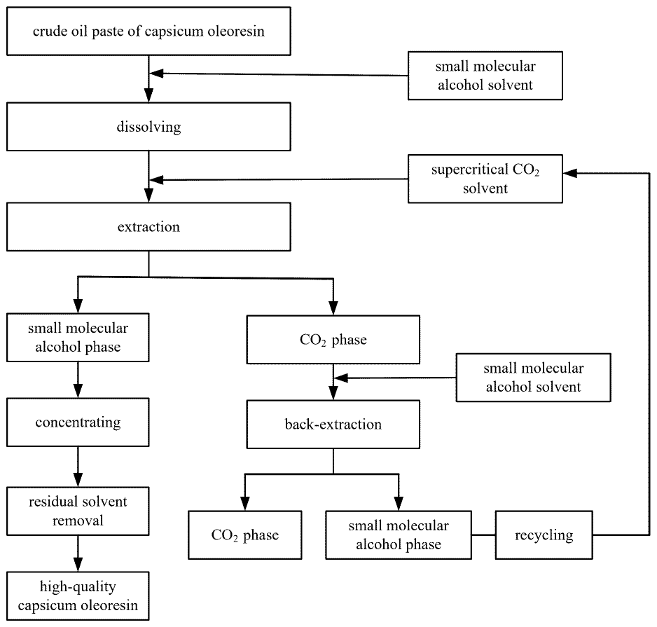

### CROSS-REFERENCE TO RELATED DISCLOSURES

The present disclosure claims priority to Chinese patent application No. 202411971025.6, filed on Dec. 30, 2024, entitled “Method for Reducing Benzopyrene and Plasticizers in Capsicum Oleoresin and Product Obtained Thereby” the entire content of which is incorporated herein by reference.

### TECHNICAL FIELD

The present disclosure relates to the field of food additive refining, and more particularly, to a method for reducing benzopyrene and plasticizers in capsicum oleoresin and product obtained thereby.

### BACKGROUND

Capsicum oleoresin is an oily liquid with high pungency obtained from chili fruits as raw materials by extraction and concentration, and has an inherent flavour and spiciness of chili, with capsaicinoids and capsanthin as main components thereof. Capsicum oleoresin exhibits important functions such as antioxidant, antibacterial, and antitumor properties, and is primarily used in the production of food additives and seasonings, and is widely used in compound seasonings, puffed foods, and pickled vegetables.

As reported in the prior art, annual sales of the capsicum oleoresin has grown exponentially in China, since Guizhou Wubeizi Co., Ltd. first introduced it to the market in 1997. By 2003, the annual sales of capsicum oleoresin in China exceeded 100 tons (products containing capsicum oleoresin at concentration of 10%). However, the domestic market has been dominated by Indian products for many years. In recent years, with the rapid development of natural product extraction technology, domestic production technology of capsicum oleoresin has also improved significantly. Domestic capsicum oleoresin gradually has a dominant position in the market, primarily due to advantage of price.

However, domestic capsicum oleoresin has significant issues such as strong oil odour and excessive levels of benzopyrene and plasticizers. The strong oil Odor in products may cause discomfort to consumers when being introduced to the market. Additionally, when the capsicum oleoresin product is used for food seasoning, an overly prominent odour of capsicum oleoresin may mask the aroma of other seasonings, to degrade the overall flavour balance. Benzopyrene, a polycyclic aromatic hydrocarbon with benzene rings, is highly carcinogenic. The primary source of benzopyrene in capsicum oleoresin lies in the high-temperature processing steps during production. For instance, during the extraction and processing on capsicum oleoresin, if the temperature is not controlled properly or the processing time is too long, components such as fats and proteins in chili may undergo thermal decomposition or thermal polymerization, so that benzopyrene is generated. Additionally, if processing apparatus or packaging materials contain benzopyrene, such benzopyrene may be transferred to capsicum oleoresin during processing. Plasticizers mainly include dibutyl phthalate (DBP) and di(2-ethylhexyl) phthalate (DEHP), which are listed as Group 2B carcinogens by the International Agency for Research on Cancer of the World Health Organization. The DBP and DEHP in capsicum oleoresin primarily due to contacting with materials containing DBP and DEHP during chili cultivation, harvesting, processing, or storage, which are lipophilic and may easily remain in chili oil products. Currently, in domestic high-concentration capsicum oleoresin (concentration >35%), the benzopyrene content reaches 80 to 150 μg/kg, DBP ranges from 2 to 20 mg/kg, and DEHP content reaches 15 to 200 mg/kg, so that there is still a gap between domestic product and products imported from India.

As reported in prior art, there are various methods for separating and purifying capsicum oleoresin, such as alkali treatment, silica gel column chromatography, and microporous adsorption resin methods. For instance, in one of the prior art, it is proposed that capsicum oleoresin is refined by using edible oil and lower alcohols to improve its pungency. In another prior art, it is recited that capsicum oleoresin may be washing with salt substances followed by extraction and refinement with mixed solvents to improve its fluidity and brightness. In another prior art, it is proposed to extract crude capsicum oleoresin and then separate it through column chromatography to obtain high-purity capsicum oleoresin. Although these prior art meet the requirements of the national standard, issues such as odour, benzopyrene, and plasticizers in domestic capsicum oleoresin remain unresolved. These issues have gradually become bottlenecks in the development of the domestic capsicum oleoresin industry.

In conclusion, it is important to skilled in the art to provide a method for reducing benzopyrene and plasticizers in capsicum oleoresin to address the quality issues in domestic capsicum oleoresin products, so as to improve its market competitiveness.

### BRIEF SUMMARY

The present disclosure is to provide a method for reducing benzopyrene and plasticizers in capsicum oleoresin. The method includes steps: dissolving crude oil paste of capsicum oleoresin as raw material with a small molecular alcohol solvent to obtain a small molecular alcohol solution of capsicum oleoresin; performing extraction and back-extraction with CO₂ and small molecular alcohol solvents, respectively in a supercritical two-stage series mode; performing extracting on the small molecular alcohol solution by using CO₂ in extraction kettle I, to obtain a CO₂ extract phase and a raffinate phase (small molecular alcohol phase); obtaining high-purity capsicum oleoresin with reduced benzopyrene and plasticizers by conducting vacuum concentration and residual solvent removal on the small molecular alcohol phase; performing back-extraction on the CO₂ extract phase by using a small molecular alcohol solvent after the CO₂ extract phase enters extraction kettle II, so as to obtain small molecular alcohol phase, which is used for dissolving the crude oil paste of capsicum oleoresin in the next batch.

With the technical solution provided by the present disclosure, the capsaicin content in the obtained capsicum oleoresin is over 70%, with an average yield of 95.89%, a removal rate of benzopyrene reaches over 88%, and removal rates of DBP and DEHP over 93% and over 98%, respectively.

To achieve the above objectives, the present disclosure provides a method for reducing benzopyrene and plasticizers in capsicum oleoresin, including the following steps:
(1) dissolving crude oil paste of capsicum oleoresin with a small molecular alcohol solvent, to obtain a small molecular alcohol solution of capsicum oleoresin;
(2) introducing obtained small molecular alcohol solution of capsicum oleoresin into an extraction kettle I; introducing a small molecular alcohol solvent into an extraction kettle II;
(3) performing supercritical CO₂ extracting on the small molecular alcohol solution of capsicum oleoresin in extraction kettle I under certain pressure, temperature, and flow rate conditions for a period of time, to obtain an extracted CO₂ phase and a small molecular alcohol phase;
(4) performing back-extraction on the CO₂ phase by using the small molecular alcohol solvent in the extraction kettle II after introducing the CO₂ phase in extraction kettle I into the extraction kettle II, so as to obtain back-extracted small molecular alcohol phase, which is used for dissolving the crude oil paste of capsicum oleoresin in the next batch;
(5) concentrating the small molecular alcohol phase in the extraction kettle I under certain temperature and pressure to obtain refined capsicum extract oil paste;
(6) performing residual solvent removal on obtained refined capsicum extract oil paste under certain temperature and pressure, so as to obtain high-purity capsicum extract oil paste.

In a preferred embodiment, in steps (1) and (2), the small molecular alcohol solvent includes C1 to C4 alcohol compounds; preferably, the small molecular alcohol solvent includes one or more of methanol, ethanol, and isopropanol; in the present disclosure, the concentration (volume fraction) of alcohol compounds in the small molecular alcohol solvent is 20% to 80%.

In the present disclosure, the alcohol compounds and their concentrations in the small molecular alcohol solvents used in steps (1) and (2) may be the same or different. Preferably, in step (1), a concentration of alcohol compounds in the small molecular alcohol solvent is 30% to 80%; in step (2), a concentration of alcohol compounds in the small molecular alcohol solvent is 40% to 60%.

In a preferred embodiment, in step (1), a mass ratio of the crude oil paste of capsicum oleoresin to the small molecular alcohol solvent is 1:(0.5-10); preferably, a mass ratio of the crude oil paste of capsicum oleoresin to the small molecular alcohol solvent is 1:(2-8).

In a preferred embodiment, in step (2), a feeding amount of the small molecular alcohol solution of capsicum oleoresin in the extraction kettle I is 1/10 to ½ of the volume of the extraction kettle; preferably, a feeding amount of the small molecular alcohol solution of capsicum oleoresin in the extraction kettle I is ⅕ to ½ of the volume of the extraction kettle.

In a preferred embodiment, in step (2), a feeding amount of the small molecular alcohol solvent in the extraction kettle II is 1/10 to ½ of the volume of the extraction kettle; preferably, a feeding amount of the small molecular alcohol solvent in the extraction kettle II is ⅕ to ½ of the volume of the extraction kettle.

In a preferred embodiment, in step (3), a supercritical extraction on the small molecular alcohol solution of capsicum oleoresin in the extraction kettle I may be conducted under a condition as follows: extraction pressure of 10-20 MPa; extraction temperature of 40-60° C.; extraction flow rate of 5-20 times a volume of solution to be extracted per hour, and extraction time of 2-8 hours; preferably, the supercritical extraction on the small molecular alcohol solution of capsicum oleoresin in extraction kettle I may be conducted under a condition as follows: pressure of 12-18 MPa; extraction temperature of 40-55° C.; extraction flow rate of 8-20 times a volume of solution to be extracted per hour.

In a preferred embodiment, in step (4), the back-extraction on the CO₂ phase in extraction kettle II may be conducted under a condition as follows: extraction pressure of 10-20 MPa; extraction temperature of 40-60° C.; extraction flow rate of 5-20 times a volume of solution to be extracted per hour, and extraction time of 2-8 hours; preferably, the back-extraction on the CO₂ phase in extraction kettle II may be conducted under a condition as follows: extraction pressure of 12-18 MPa; extraction temperature of 40-55° C.; extraction flow rate of 8-20 times a volume of solution to be extracted per hour.

In a preferred embodiment, in step (4), when the back-extraction is completed, a pressure in a separation device I is 6-8 MPa, and a temperature in a separation device I is 40-50° C.; a pressure in a separation device II is 4-6 MPa, and a temperature in a separation device II is 40-50° C.

In a preferred embodiment, in step (5), the concentrating on the small molecular alcohol phase in the extraction kettle I may be conducted under a condition as follows: concentration temperature of 40-90° C. and concentration pressure of −0.02 to −0.08 MPa.

In a preferred embodiment, in step (6), the residual solvent removal on the refined capsicum extract oil paste may be conducted under a condition as follows: concentration temperature of 60-100° C. and residual solvent removal pressure of −0.06 to −0.09 MPa. Preferably, the residual solvent removal on the refined capsicum extract oil paste may be conducted under a condition as follows: residual solvent removal temperature of 70-90° C. and residual solvent removal pressure of −0.07 to −0.09 MPa.

In the present disclosure, the small molecular alcohol phase in the extraction kettle I is subjected to concentrating to recycle solvent from the solution containing a significant amount of solvent, so as to obtain concentrated oil paste. The refined capsicum extract oil paste is subjected to residual solvent removal is to further remove solvents from the concentrated oil paste containing trace amounts of solvent, so that there is an extremely low level of solvent residue in the concentrated oil paste. With on purposes described above, a reaction temperature and pressure for the concentrating in the present disclosure are to be relatively low, so as to facilitate the preserving of active components, while the temperature and pressure for residual solvent removal are relatively high, which is beneficial for improving the efficiency of solvent removal.

In a preferred embodiment, in step (6), a capsaicin content in the high-purity capsicum extract oil paste prepared may be over 70%, with an average yield of 95.89%. The removal rate of benzopyrene may be over 88%, and the removal rates of DBP and DEHP may be over 93% and over 98%, respectively.

Another objective of the present disclosure is to provide capsicum oleoresin prepared by the method described in any of the above embodiments for reducing benzopyrene and plasticizers in capsicum oleoresin. The capsicum oleoresin is blended with edible oil to form capsicum oleoresin with a mass concentration of 10%, which has a benzopyrene content ≤10 μg/kg, DBP content≤0.3 mg/kg, and DEHP content≤1.5 mg/kg, with no obvious capsicum odor.

In a preferred embodiment, the edible oil includes one or more of soybean oil, sunflower seed oil, and rapeseed oil.

Compared to the prior art, the technical solution of the present disclosure has the following advantages:

In the present disclosure, small molecular alcohol is first used in a specific ratio to dissolve the crude extract of capsicum oleoresin. Then, in a supercritical two-stage series mode, the capsicum oleoresin alcohol solution in extraction kettle I is subjected to extraction by using CO₂. This not only effectively separates the fat-soluble impurities from capsaicin in the crude extract but also simultaneously removes odor, benzopyrene, and plasticizers, so that capsicum oleoresin products with high content, low odor, and low levels of benzopyrene and plasticizers may be obtained. The CO₂ phase obtained after the first extraction is then subjected to back-extraction with small molecular alcohol in extraction kettle II, so that part of the capsaicin carried in the CO₂ phase back may be recycled into the small molecular alcohol phase, which may be then applied to dissolve the crude extract of capsicum oleoresin, to significantly improve the refining yield of capsicum oleoresin.

With the technical solution of the present disclosure, not only is the content of capsicum oleoresin effectively increased, but the fluidity and state of the product when formulated into low-concentration products are also improved. Simultaneously, the levels of capsicum odor, benzopyrene, and plasticizers are reduced, and thus the overall quality of capsicum oleoresin products may be improved. Moreover, the process conditions used herein are environmentally friendly and suitable for industrial production, to offer a reference for the industrial development of capsicum oleoresin.

### BRIEF DESCRIPTION OF THE DRAWINGS

Based on the following detailed description of the embodiments of the disclosure in conjunction with the drawings, these and/or other aspects and advantages of the disclosure will become clearer and easier to understand, wherein:

The FIGURE is a process flow diagram of the method provided by the present disclosure.

### DETAILED DESCRIPTION

For better understanding on the present disclosure by the skilled in the art, detailed description on the present disclosure is further provided in conjunction with the drawings and embodiments. However, it should be understood that the scope of protection of the present disclosure is not limited by the embodiments.

The embodiments of the disclosure provide a method for reducing benzopyrene and plasticizers in capsicum oleoresin and a product obtained thereby, to address the issues of strong odor, high benzopyrene, and plasticizer content in capsicum oleoresin prepared in the prior art.

The technical solution of this application is described in detail through specific embodiments as follows:

Unless specifically indicated otherwise, the technical means used in the present disclosure are conventional methods well known to those skilled in the art. The various raw materials, reagents, instruments, and equipment used in the disclosure can be commercially purchased or prepared by existing methods. Unless otherwise specified, the reagents used in the disclosure are analytically pure. The capsicum oleoresin crude extract used in the embodiments of the disclosure is a crude oil paste of capsicum oleoresin produced by Henan Zhongda Hengyuan Biotechnology Co., Ltd.

The method for detecting benzopyrene content used in the present disclosure is GB 5009.27-2016 National Food Safety Standard for the determination of benzo[a]pyrene in food; the method for detecting DBP and DEHP content is GB 5009.271-2016 National Food Safety Standard for the determination of phthalates in food.

### Embodiment 1

a) adding 30 kg of 75% methanol into 10 kg of capsicum oleoresin crude extract (capsaicin content of 32.18%; benzopyrene content of 87.66 μg/kg; DBP content of 2.84 mg/kg, DEHP content of 82.64 mg/kg), and then performing stirring and mixing the same at room temperature to obtain a small molecular alcohol solution of capsicum oleoresin;

b) introducing the small molecular alcohol solution of capsicum oleoresin into the extraction kettle I, and introducing 30 kg of 75% methanol into the extraction kettle II. Extraction pressure is 15 MPa and extraction temperature is 45° C. in extraction kettles I and II; pressure is 8 MPa in separation device I, temperature is 40° C. in separation device I; pressure is 4 MPa in separation device II, temperature is 40° C. in separation device II. Extraction is carried out for 4 hours at a flow rate of 300-320 L/h to obtain raffinate of capsicum oleoresin (small molecular alcohol phase) in extraction kettle I and small molecular alcohol back-extraction solution in extraction kettle II.

c) performing concentrating on the raffinate of capsicum oleoresin from extraction kettle I at 75-80° C. and −0.07 to −0.09 MPa until the solvent residue is less than 1%, to obtain refined capsicum extract oil paste. The small molecular alcohol back-extraction solution from extraction kettle II is used for dissolving the crude extract of capsicum oleoresin in the next batch.

d) performing residual solvent removal on the refined capsicum extract oil paste at 80-90° C. and −0.07 to −0.09 MPa, to obtain 4.24 kg of high-purity capsicum extract oil paste product with a capsaicin content of 73.12%, benzopyrene content of 28.83 μg/kg, DBP content of 0.51 mg/kg, and DEHP content of 2.48 mg/kg. The product has no significant residual capsicum odor.

### Embodiment 2

a) adding 12 kg of 70% methanol into 6 kg of capsicum oleoresin crude extract (capsaicin content of 35.75%; benzopyrene content of 105.42 μg/kg; DBP content of 4.16 mg/kg, DEHP separation of 64.25 mg/kg), and then performing stirring and mixing the same at room temperature to obtain a small molecular alcohol solution of capsicum oleoresin;

b) introducing the small molecular alcohol solution of capsicum oleoresin into the extraction kettle I, and introducing 20 kg of 70% methanol into the extraction kettle II. Extraction pressure is 18 MPa and extraction temperature is 40° C. in extraction kettles I and II; pressure is 8 MPa in separation device I, temperature is 40° C. in separation device I; pressure is 4 MPa in separation device II, temperature is 40° C. in separation device II. Extraction is carried out for 3 hours at a flow rate of 350-380 L/h to obtain raffinate of capsicum oleoresin (small molecular alcohol phase) in extraction kettle I and small molecular alcohol back-extraction solution in extraction kettle II.

c) performing concentrating on the raffinate of capsicum oleoresin from extraction kettle I at 82-87° C. and −0.06 to −0.08 MPa until the solvent residue is less than 1%, to obtain refined capsicum extract oil paste. The small molecular alcohol back-extraction solution from extraction kettle II is used for dissolving the crude extract of capsicum oleoresin in the next batch.

d) performing residual solvent removal on the refined capsicum extract oil paste at 78-88° C. and −0.07 to −0.09 MPa, to obtain 2.67 kg of high-purity capsicum extract oil paste product with a capsaicin content of 75.86%, benzopyrene content of 25.37 μg/kg, DBP content of 0.38 mg/kg, and DEHP content of 1.64 mg/kg. The product has no significant residual capsicum odor.

### Embodiment 3

a) adding 20 kg of 70% methanol into 6 kg of capsicum oleoresin crude extract (capsaicin content of 30.87%; benzopyrene content of 1118.33 μg/kg; DBP content of 2.97 mg/kg, DEHP content of 40.17 mg/kg), and then performing stirring and mixing the same at room temperature to obtain a small molecular alcohol solution of capsicum oleoresin;

b) introducing the small molecular alcohol solution of capsicum oleoresin into the extraction kettle I, and introducing 20 kg of 70% methanol into the extraction kettle II. Extraction pressure is 12 MPa and extraction temperature is 50° C. in extraction kettles I and II; pressure is 8 MPa in separation device I, temperature is 40° C. in separation device I; pressure is 4 MPa in separation device II, temperature is 40° C. in separation device II. Extraction is carried out for 3.5 hours at a flow rate of 380-400 L/h to obtain raffinate of capsicum oleoresin (small molecular alcohol phase) in extraction kettle I and small molecular alcohol back-extraction solution in extraction kettle II.

c) performing concentrating on the raffinate of capsicum oleoresin from extraction kettle I at 80-85° C. and −0.06 to −0.08 MPa until the solvent residue is less than 1%, to obtain refined capsicum extract oil paste. The small molecular alcohol back-extraction solution from extraction kettle II is used for dissolving the crude extract of capsicum oleoresin in the next batch.

d) performing residual solvent removal on the refined capsicum extract oil paste at 80-90° C. and −0.07 to −0.09 MPa, to obtain 2.47 kg of high-purity capsicum extract oil paste product with a capsaicin content of 71.48%, benzopyrene content of 31.44 μg/kg, DBP content of 0.60 mg/kg, and DEHP content of 2.87 mg/kg. The product has no significant residual capsicum odor.

### Comparative Example 1

a) introducing 10 kg of capsicum oleoresin crude extract (capsaicin content of 32.18%; benzopyrene content of 87.66 μg/kg; DBP content of 2.84 mg/kg, DEHP content of 82.64 mg/kg) directly into the extraction kettle. Extraction pressure is 12 MPa and extraction temperature is 50° C. in extraction kettle; pressure is 8 MPa in separation device I, temperature is 40° C. in separation device I; pressure is 4 MPa in separation device II, temperature is 40° C. in separation device II. Extraction is carried out for 4 hours at a flow rate of 380-400 L/h to obtain raffinate of capsicum oleoresin (small molecular alcohol phase) in extraction kettle.

b) performing residual solvent removal on the raffinate of capsicum oleoresin at 80-90° C. and −0.07 to −0.09 MPa, to obtain 5.56 kg of high-purity oleoresin product with a capsaicin content of 45.87%, benzopyrene content of 76.42 μg/kg, DBP content of 2.06 mg/kg, and DEHP content of 67.41 mg/kg. The product has no significant residual capsicum odor.

### Comparative Example 2

a) adding 40 kg of 70% ethanol into 10 kg of capsicum oleoresin crude extract (capsaicin content of 32.18%; benzopyrene content of 87.66 μg/kg; DBP content of 2.84 mg/kg, DEHP content of 82.64 mg/kg), and then performing stirring on the same at 50° C. for 30 minutes, to obtain a small molecular alcohol solution of capsicum oleoresin;

b) performing standing at 50° C. for stratification for 1 hour, and discharging lower alcohol phase is slowly while performing extracting on the upper layer 4 times in total using the method described in a), and the lower solutions are combined to obtain a refined solution of capsicum oleoresin.

c) performing concentrating on the refined solution of capsicum oleoresin at 75-80° C. and −0.07 to −0.09 MPa until the solvent residue is less than 1%, to obtain refined capsicum extract oil paste.

d) performing residual solvent removal on the refined capsicum extract oil paste at 80-90° C. and −0.07 to −0.09 MPa, to obtain 7.20 kg of high-purity capsicum extract oil paste product with a capsaicin content of 41.92%, benzopyrene content of 78.34 μg/kg, DBP content of 3.17 mg/kg, and DEHP content of 79.68 mg/kg. The product has significant residual capsicum odor.

### Application 1

Analyzation and test are made on the refined capsicum extract oil paste prepared in Embodiments 1-3 and Comparative Examples 1-2, and the results are shown in Table 1.

TABLE 1

| | | | Test Number | | | | |
|---|---|---|---|---|---|---|---|
| | | | Embodi- | Embodi- | Embodi- | Comparative | Comparative |
| Detection Item | | | ment 1 | ment 2 | ment 3 | Example 1 | Example 2 |
| capsicum | capsaicin content/% | | 32.18 | 35.75 | 30.87 | 32.18 | 32.18 |
| oleoresin | benzopyrene content/% | | 87.66 | 105.42 | 118.33 | 87.66 | 87.66 |
| crude | plasticizer | DBP content/mg/kg | 2.84 | 4.16 | 2.97 | 2.84 | 2.84 |
| extract | | DEHP content/mg/kg | 82.64 | 64.25 | 40.17 | 82.64 | 82.64 |
| capsicum | capsaicin content/% | | 73.12 | 75.86 | 71.48 | 45.87 | 41.92 |
| oleoresin | capsaicin average content | | 72.3 | | | / | / |
| refined | refined product yield/% | | 96.28 | 94.26 | 95.5 | 79.24 | 93.77 |
| product | average refined product | | 95.89 | | | / | / |
| | yield/% | | | | | | |
| | product odour | | Not | Not | Not | Not | Significant |
| | | | obvious | obvious | obvious | obvious | odour |
| | Benzopyrene/% | | 28.83 | 25.37 | 31.44 | 76.42 | 78.34 |
| | Benzopyrene removal | | 86.06 | 89.31 | 89.04 | 51.54 | 35.67 |
| | rate/% | | | | | | |
| | Average benzopyrene | | 88.14 | | | / | / |
| | removal rate/% | | | | | | |
| | plasticizer | DBP content/mg/kg | 0.51 | 0.38 | 0.60 | 2.06 | 3.17 |
| | | DBP removal rate/% | 92.39 | 95.94 | 91.67 | 59.68 | 19.65 |

| Average DBP removal | 93.33 | | | / | / |
|---|---|---|---|---|---|
| rate/% | | | | | |
| DEHP content/mg/kg | 2.48 | 1.64 | 2.87 | 67.41 | 79.68 |
| DBP removal rate/% | 98.73 | 98.87 | 97.05 | 54.65 | 30.60 |
| Average DBP removal | 98.22 | | | / | / |
| rate/% | | | | | |

It can be concluded from the analysis results in Table 1

(1) The capsaicin content in embodiments is 71.48-75.86%, with an average content of 72.30%, showing a 57.61% improvement compared to Comparative Example 1 and a 72.47% improvement compared to Comparative Example 2. The refined yield in embodiments is 94.26-96.28%, with an average of 95.89%, showing a 21.01% improvement compared to Comparative Example 1 and a 2.26% improvement compared to Comparative Example 2.

(2) The refined capsicum oleoresin in embodiments has no significant capsicum odor; the refined capsicum oleoresin in Comparative Example 1 also has no significant capsicum odor, while the refined capsicum oleoresin in Comparative Example 2 has a significant capsicum odor.

(3) The benzopyrene content in embodiments is 28.83-31.44 μg/kg, with a removal rate of 86.06-89.31% and an average removal rate of 88.14%, showing 0.71-times improvement compared to Comparative Example 1 and 1.47-times improvement compared to Comparative Example 2.

(4) The DBP content in embodiments is 0.38-0.60 mg/kg, with a removal rate of 91.67-95.94% and an average removal rate of 93.33%, showing that a 0.56-times improvement compared to Comparative Example 1 and a 3.75-times improvement compared to Comparative Example 2. The DEHP content is 1.64-2.87 mg/kg, with a removal rate of 97.05-98.87% and an average removal rate of 98.22%, showing a 0.80-times improvement compared to Comparative Example 1 and a 2.21-times improvement compared to Comparative Example 2.

### Application 2

Capsicum extract oil paste products prepared in Embodiments 1-3 and Comparative Examples 1-2 was blended with soybean oil to prepare capsicum oleoresin products with mass concentrations of 6.6% and 10%, and analyzed. The results are shown in Table 2.

TABLE 2

| | | | Test Number | | | | |
|---|---|---|---|---|---|---|---|
| | | | Embodi- | Embodi- | Embodi- | Comparative | Comparative |
| Detection Item | | | ment 1 | ment 2 | ment 3 | Example 1 | Example 2 |
| Preparation | capsaicin content/% | | 32.18 | 35.75 | 30.87 | 32.18 | 32.18 |
| of 6.6% | benzopyrene content/% | | 87.66 | 105.42 | 118.33 | 87.66 | 87.66 |
| Capsicum | plasticizer | DBP content/mg/kg | 2.84 | 4.16 | 2.97 | 2.84 | 2.84 |
| Oleoresin | | DEHP content/mg/kg | 82.64 | 64.25 | 40.17 | 82.64 | 82.64 |
| Preparation | capsaicin content/% | | 73.12 | 75.86 | 71.48 | 45.87 | 41.92 |
| of 10% | benzopyrene content/% | | 72.3 | | | / | / |
| Capsicum | plasticizer | DBP content/mg/kg | 0.51 | 0.38 | 0.60 | 2.06 | 3.17 |
| Oleoresin | | DEHP content/mg/kg | 2.48 | 1.64 | 2.87 | 67.41 | 79.68 |

It can be concluded from the analysis results in Table 2

(1) The benzopyrene content in the 6.6% and 10% capsicum oleoresin products prepared in the embodiments is 2.24-3.02 μg/kg and 3.46-4.55 μg/kg, respectively, meeting the requirement of being ≤10 μg/kg. The benzopyrene content in the 6.6% and 10% capsicum oleoresin products prepared in Comparative Example 1 is 11.48 μg/kg and 17.21 μg/kg, respectively, and that of Comparative Example 2 is 13.82 μg/kg and 18.94 μg/kg, respectively, which do not meet the requirement of being ≤10 μg/kg.

(2) The DBP content in the 6.6% and 10% capsicum oleoresin products prepared in the embodiments is 0.05-0.07 mg/kg and 0.06-0.11 mg/kg, respectively, meeting the requirement of being ≤0.3 mg/kg. The DBP content in the 6.6% and 10% capsicum oleoresin products prepared in Comparative Example 1 is 0.34 mg/kg and 0.48 mg/kg, respectively, and that of Comparative Example 2 is 0.52 mg/kg and 0.77 mg/kg, respectively, which do not meet the requirement of being ≤0.3 mg/kg.

(3) The DEHP content in the 6.6% and 10% capsicum oleoresin products prepared in the embodiments is 0.20-0.28 mg/kg and 0.28-0.44 mg/kg, respectively, meeting the requirement of being ≤1.50 mg/kg. The DEHP content in the 6.6% and 10% capsicum oleoresin products prepared in Comparative Example 1 is 9.84 mg/kg and 15.76 mg/kg, respectively, and that of Comparative Example 2 is 12.60 mg/kg and 21.47 mg/kg, respectively, which do not meet the requirement of being ≤1.50 mg/kg.

In summary, in the present disclosure supercritical CO₂ is used as a solvent for the first time and adopts a first-stage extraction and second-stage back-extraction manner to perform two-stage tandem extraction on the small molecular alcohol solution of capsicum oleoresin crude extract. After concentration and residual solvent removal of the raffinate, capsicum oleoresin with a content of over 70% and an average yield of 95.89% is obtained. The benzopyrene removal rate reaches over 88%, and the DBP and DEHP removal rates reach over 93% and over 98%, respectively. The 10% capsicum oleoresin prepared meets the requirements on benzopyrene to be ≤10 μg/kg, DBP≤0.3 mg/kg, and DEHP≤1.5 mg/kg, with no significant capsicum odor.

Compared to products in the prior art, the production process provided by the disclosure has obvious advantages in improving the content and yield of refined capsicum oleoresin products and removing odor, benzopyrene, and plasticizers. Additionally, the capsicum oleoresin produced by the disclosure may be applied to the formulation of both oil-soluble and water-soluble products, and meet food application requirements and significantly improve safety indicators such as benzopyrene and plasticizers, so that capsicum oleoresin may be significantly superior to products produced in prior art.

The foregoing description of specific exemplary embodiments of the present disclosure is provided for illustrative and explanatory purposes. These descriptions are not intended to limit the disclosure to the precise forms disclosed, and it is evident that many modifications and variations can be made in light of the above teachings. The exemplary embodiments are selected and description to explain the particular principles of the disclosure and its practical applications, so that those skilled in the art may implement and utilize various exemplary embodiments of the disclosure as well as various choices and modifications. The scope of the disclosure is intended to be defined by the claims and their equivalents.

1. A method for reducing benzopyrene and plasticizers in capsicum oleoresin, comprising steps: dissolving crude oil paste of capsicum oleoresin as raw material with a small molecular alcohol solvent to obtain a small molecular alcohol solution of capsicum oleoresin; performing extraction and back-extraction with CO₂ and small molecular alcohol solvents, respectively in a supercritical two-stage series mode; obtaining high-purity capsicum oleoresin with reduced benzopyrene and plasticizers by conducting vacuum concentration and residual solvent removal on the small molecular alcohol phase obtained by extraction; small molecular alcohol phase is used for dissolving the crude oil paste of capsicum oleoresin in the next batch.

2. The method for reducing benzopyrene and plasticizers in capsicum oleoresin according to claim 1, further comprising steps:
(1) dissolving crude oil paste of capsicum oleoresin with a small molecular alcohol solvent, to obtain a small molecular alcohol solution of capsicum oleoresin;
(2) introducing obtained small molecular alcohol solution of capsicum oleoresin into an extraction kettle I; introducing a small molecular alcohol solvent into an extraction kettle II;
(3) performing supercritical CO₂ extracting on the small molecular alcohol solution of capsicum oleoresin in extraction kettle I under a pressure, temperature, and flow rate conditions for a period of time, to obtain an extracted CO₂ phase and a small molecular alcohol phase;
(4) performing back-extraction on the CO₂ phase by using the small molecular alcohol solvent in the extraction kettle II after introducing the CO₂ phase in extraction kettle I into the extraction kettle II, so as to obtain back-extracted small molecular alcohol phase, which is used for dissolving the crude oil paste of capsicum oleoresin in the next batch;
(5) concentrating the small molecular alcohol phase in the extraction kettle I under a temperature and pressure to obtain refined capsicum extract oil paste;
(6) performing residual solvent removal on obtained refined capsicum extract oil paste under a temperature and pressure, so as to obtain high-purity capsicum extract oil paste.

3. The method for reducing benzopyrene and plasticizers in capsicum oleoresin according to claim 2, wherein in steps (1) and (2), the small molecular alcohol solvent comprises C1 to C4 alcohol compounds.

4. The method for reducing benzopyrene and plasticizers in capsicum oleoresin according to claim 2, wherein in step (1), a mass ratio of the crude oil paste of capsicum oleoresin to the small molecular alcohol solvent is 1:(0.5-10).

5. The method for reducing benzopyrene and plasticizers in capsicum oleoresin according to claim 2, wherein in step (3), a supercritical extraction on the small molecular alcohol solution of capsicum oleoresin in the extraction kettle I is conducted under a condition as follows: extraction pressure of 10-20 MPa; extraction temperature of 40-60° C.; extraction flow rate of 5-20 times a volume of solution to be extracted per hour, and extraction time of 2-8 hours.

6. The method for reducing benzopyrene and plasticizers in capsicum oleoresin according to claim 2, wherein in step (4), the back-extraction on the CO₂ phase in extraction kettle II is conducted under a condition as follows: extraction pressure of 10-20 MPa; extraction temperature of 40-60° C.; extraction flow rate of 5-20 times a volume of solution to be extracted per hour, and extraction time of 2-8 hours.

7. The method for reducing benzopyrene and plasticizers in capsicum oleoresin according to claim 2, wherein in step (5), the concentrating on the small molecular alcohol phase in the extraction kettle I is conducted under a condition as follows: concentration temperature of 40-90° C. and concentration pressure of −0.02 to −0.08 MPa;
the residual solvent removal on the refined capsicum extract oil paste is conducted under a condition as follows: concentration temperature of 60-100° C. and residual solvent removal pressure of −0.06 to −0.09 MPa.

8. The method for reducing benzopyrene and plasticizers in capsicum oleoresin according to claim 2, wherein in step (6), the capsaicin content in the obtained capsicum oleoresin is over 70%, with an average yield of 95.89%, a removal rate of benzopyrene reaches over 88%, and removal rates of DBP and DEHP over 93% and over 98%, respectively.

9. A capsicum oleoresin obtained by the method for reducing benzopyrene and plasticizers in capsicum oleoresin according to claim 1.

10. The capsicum oleoresin according to claim 9, wherein the capsicum oleoresin is blended with edible oil to form capsicum oleoresin with a mass concentration of 10%, which has a benzopyrene content≤10 μg/kg, DBP content≤0.3 mg/kg, and DEHP content≤1.5 mg/kg, with no obvious capsicum odor.
